(19) United States
(12) Patent Application Publication
(10) Pub. No.: US 2011/0011469 A1
(43) Pub. Date: Jan. 20, 2011

(54) TRANSMISSION HYDRAULIC CIRCUIT, TRANSMISSION PROVIDED THEREWITH AND VEHICLE EQUIPPED WITH SAME

(75) Inventor: Satoshi Annaka, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/921,684

(22) PCT Filed: Mar. 9, 2009
(86) PCT No.: PCT/IB2009/000459

§ 371 Date: Sep. 9, 2010

(30) Foreign Application Priority Data
Mar. 10, 2008 (JP) 2008-059492

(51) Int. Cl. B01D 35/00; F17D 1/00

(52) U.S. Cl. 137/544; 137/565.01

(57) ABSTRACT

A hydraulic circuit (50) is provided with an oil cooler (180), a lubricating unit (200), a relief valve (210) and an oil pan (100). The lubricating unit (200) receives hydraulic oil cooled by the cooler (180) as lubricating oil and discharges the same to the oil pan (100). The relief valve (210) regulates oil pressure within an oil path (190) by discharging a portion of the hydraulic oil from the oil path (190). The oil cooler (180) is arranged upstream of the lubricating unit (200) and the relief valve (210), and cools the hydraulic oil flowing to the lubricating unit (200) and the relief valve (210).

### BACKGROUND OF THE INVENTION

1. Field of the Invention

The invention relates to a transmission hydraulic circuit, a transmission provided therewith, and a vehicle equipped with the transmission, and more particularly, to a cooling technology for hydraulic oil used in a transmission hydraulic circuit.

2. Description of the Related Art

Japanese Patent Application Publication No. 2001-227631 (JP-A-2001-227631) explains a hydraulic control device of a continuously variable transmission (CVT). In this hydraulic control device, an intake port of an oil pump communicated with an oil pan via an oil strainer. A discharge port of the oil pump is connected to an oil supply port by a line pressure path and to a secondary pressure port of a secondary valve. A lubrication pressure path is connected to a drain port of the secondary valve, and hydraulic oil is supplied to a forward-reverse switching mechanism, belt lubricating unit and the like by this lubrication pressure path. Lubrication pressure of the lubrication pressure path is regulated by a lubrication pressure valve based on the drain pressure of the secondary valve. An oil cooler is provided in a cooling path communicable with the lubrication pressure path via a switching valve.

JP-A-2001-227631 explains another embodiment in the form of a configuration in which a lubricating oil supply path is connected downstream from an oil cooler, and hydraulic oil that has been passed through the oil cooler by this lubrication oil supply path is supplied to a lubricating unit of a forward-reverse switching mechanism.

After hydraulic oil that has accumulated in an oil pan is suctioned from the oil pan by an oil pump and circulated through a transmission, it is returned to the oil pan. Here, when the temperature of the hydraulic oil rises due to a lack of oil cooling capacity, the oil level in the oil pan rises due to an expansion of the volume of the hydraulic oil. When the oil level in the oil pan rises, the oil temperature rises further due to an increase in resistance of the oil to agitation by a rotating body, thereby resulting in a further rise in the oil level within the oil pan. The rise in the oil level in the oil pan leads to a decrease in transmission efficiency due to increased resistance to agitation by the rotating body.

Thus, in the hydraulic control device disclosed in JP-A-2001-227631 above, since the flow rate of oil passing through the oil cooler is low, there is the possibility of being unable to ensure adequate oil cooling capacity. In addition, replacing an existing oil cooler with an oil cooler having higher cooling efficiency leads to increase in costs.

### SUMMARY OF THE INVENTION

This invention provides a transmission hydraulic circuit capable of improving oil cooling capacity at low cost, a transmission provided therewith, and a vehicle equipped with that transmission.

In a first aspect of the invention, the invention relates to a transmission hydraulic circuit. This transmission hydraulic circuit is provided with an oil pan in which hydraulic oil accumulates, an oil path through which the hydraulic oil flows, a lubricating unit that receives the hydraulic oil from the oil path as lubricating oil and is configured to enable the lubricating oil to be discharged to the oil pan, and a hydraulic control valve configured to enable regulation of hydraulic pressure within the oil path by discharging a portion of the oil from the oil path. The transmission hydraulic circuit is further provided with a cooler arranged upstream of the lubricating unit and the hydraulic control valve and configured to enable cooling of hydraulic oil flowing from the oil path into the lubricating unit and the hydraulic control valve.

According to the aspect described above, the hydraulic control valve regulates oil pressure within the oil path by discharging a portion of the oil from the oil path. Since the cooler capable of cooling the hydraulic oil is arranged upstream of the lubricating unit and the hydraulic control valve in the oil path, the amount of oil passing through the cooler increases as compared with a hydraulic circuit in which only hydraulic oil supplied to the lubricating unit is cooled. Thus, according to this hydraulic circuit, hydraulic oil can be cooled effectively and at low cost without providing a separate high-performance cooler.

In the aspect described above, the transmission hydraulic circuit may further be provided with a pump for generating oil pressure by suctioning hydraulic oil accumulated in the oil pan, and a reflux circuit configured to be able to supply oil discharged from the hydraulic control valve to an intake port of the pump.

In the aspect described above, the transmission hydraulic circuit may be further provided with an oil strainer provided between the oil pan and the pump. The reflux circuit may be connected between the oil strainer and the pump.

According to the aspect described above, cooled oil discharged from the hydraulic control valve is re-supplied to the pump without dropping into the oil pan as a result of providing the reflux circuit. Thus, according to this hydraulic circuit, the suction load of the pump can be reduced. In addition, the temperature of hydraulic oil circulating through the hydraulic circuit is stabilized (decrease in temperature).

In the aspect described above, the transmission hydraulic circuit may be further provided with a balancing path branched from the oil path between the cooler and the lubricating unit and configured to enable the hydraulic oil to be supplied to a balance chamber for generating oil pressure in opposition to centrifugal oil pressure generated as a result of rotation of a rotating body of the transmission. The cooler may cool hydraulic oil flowing from the oil path to the lubricating unit, the hydraulic control valve and the balancing path.

According to the aspect described above, a balancing path is further provided that is branched from the oil path between the cooler and the lubricating unit. Since the cooler is arranged upstream of the lubricating unit, the hydraulic control valve and the balancing path, the amount of oil passing through the cooler is further increased. Thus, according to this hydraulic circuit, hydraulic oil can be cooled more effectively.

A second aspect of the invention relates to a transmission hydraulic circuit. This transmission hydraulic circuit is provided with an oil pan in which hydraulic oil accumulates, an oil path through which the hydraulic oil flows, a lubricating unit that receives the hydraulic oil as lubricating oil from the oil path and is configured to enable the lubricating oil to be discharged to the oil pan, and a hydraulic control valve configured to enable regulation of hydraulic pressure within the oil path by discharging a portion of the oil from the oil path. The transmission hydraulic circuit is further provided with a cooler arranged downstream of a branching point in the oil path between the lubricating unit and the hydraulic control valve, and upstream or downstream of the lubricating unit, and configured to be able to cool hydraulic oil flowing from the oil path to the lubricating unit; and a cooler arranged downstream of a branching point in the oil path between the lubricating unit and the hydraulic control valve, and upstream or downstream of the hydraulic control valve, and configured to be able to cool hydraulic oil flowing from the oil path to the hydraulic control valve.

In the aspect described above, the transmission hydraulic circuit may be further provided with a pump for generating oil pressure by suctioning hydraulic oil accumulated in the oil pan, and a reflux circuit configured to be able to supply oil discharged from the hydraulic control valve or the cooler to an intake port of the pump.

In the aspect described above, the transmission hydraulic circuit may be further provided with an oil strainer provided between the oil pan and the pump. The reflux circuit may be connected between the oil strainer and the pump.

In the aspect described above, the transmission hydraulic circuit may be further provided with a balancing path branched from the oil path downstream of the cooler and configured to enable the hydraulic oil to be supplied to a balance chamber for generating oil pressure in opposition to centrifugal oil pressure generated as a result of rotation of a rotating body of the transmission. The cooler may cool hydraulic oil flowing from the oil path to the lubricating unit and the balancing path.

A third aspect of the invention relates to a transmission. The transmission is provided with the hydraulic circuit as claimed in the first and second aspects described above.

According to the aspect described above, since the amount of oil passing through the cooler increases as compared with a transmission having a hydraulic circuit that cools only hydraulic oil supplied to a lubricating unit of the transmission, hydraulic oil of a hydraulic circuit can be cooled effectively and at low cost without providing a separate high-performance cooler. Thus, according to this transmission, a rise in the oil level in an oil pan is inhibited, and as a result thereof, a decrease in efficiency of the transmission can be prevented.

A fourth aspect of the invention relates to a vehicle equipped with a transmission. A vehicle equipped with a transmission is provided with a hydraulic circuit as claimed in the first and second aspects described above.

According to the aspect described above, since a transmission is equipped capable of increasing the amount of oil passing through a cooler as compared with a transmission having a hydraulic circuit that cools only hydraulic oil supplied to a lubricating unit of the transmission, hydraulic oil of the hydraulic circuit in the transmission can be effectively cooled at low cost without providing a separate high-performance cooler. Thus, according to this vehicle, a rise in the oil level in an oil pan is inhibited, and as a result thereof, poor fuel consumption can be prevented by preventing a decrease in efficiency of the transmission.

According to the aspects described above, hydraulic oil can be effectively cooled at low cost without providing a separate high-performance cooler. As a result, poor fuel consumption can be prevented by preventing a decrease in efficiency of the transmission.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block drawing for schematically explaining a power transmission mechanism of a vehicle equipped with a transmission provided with a hydraulic circuit according to a first embodiment of the invention;

FIG. 2 is a circuit drawing showing the configuration of the hydraulic circuit shown in FIG. 1;

FIG. 3 is a drawing showing the configuration of a hydraulic circuit according to a second embodiment;

FIG. 4 is a drawing showing the configuration of a hydraulic circuit according to a third embodiment;

FIG. 5 is a drawing showing the configuration of a hydraulic circuit according to a fourth embodiment;

FIG. 6 is a drawing showing the configuration of a hydraulic circuit according to a fifth embodiment; and

FIG. 7 is a drawing showing the configuration of a hydraulic circuit according to a sixth embodiment.

### DETAILED DESCRIPTION OF EMBODIMENTS

The following provides a detailed explanation of embodiments of the invention with reference to the drawings. Furthermore, the same numerals are used to indicate the same or equivalent elements in the drawings, and explanations thereof are not repeated.

### First Embodiment

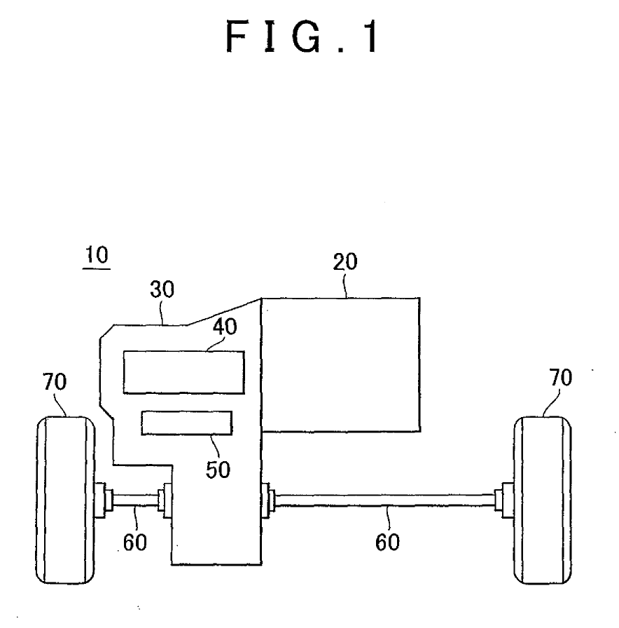

FIG. 1 is a block drawing for schematically explaining a power transmission mechanism of a vehicle equipped with a transmission provided with a hydraulic circuit according to a first embodiment of the invention. Furthermore, although FIG. 1 illustrates a representative explanation of a front engine, front drive (FF) vehicle, the invention can also be applied to a vehicle other than an FF vehicle.

A vehicle 10 is provided with a power generating device 20, a transmission 30, drive shafts 60 and rear wheels 70. The transmission 30 includes a speed changing unit 40 and a hydraulic circuit 50.

The power generating device 20 outputs drive power for driving the vehicle to the transmission 30. The power generating device 20 is, for example, an engine, a rotary motor or a hybrid system combining the use of an engine and a rotary motor.

The speed changing unit 40 of the transmission 30 changes the output rotating speed from the power generating device 20 to a desired rotating speed by forming a desired gear level using oil pressure supplied from the hydraulic circuit 50. The speed changing unit 40 is composed of, for example, a planetary gear unit. The output of the speed changing unit 40 is output to the drive shafts 60 through a differential gear not shown. Furthermore, a CVT using pairs of pulleys and belts may also be used for the speed changing unit 40 instead of a planetary gear unit.

The hydraulic circuit 50 of the transmission 30 generates oil pressure to rearrange frictional engagement elements (such as a clutch or brake) for forming a desired gear level in the speed changing unit 40. In addition, the hydraulic circuit 50 supplies lubricating oil to a lubricating unit requiring lubrication in the speed changing unit 40. Furthermore, a detailed explanation of the hydraulic circuit 50 is provided hereinafter.

The drive shafts 60 transmit drive force output from the transmission 30 to the rear wheels 70. The vehicle 10 travels as a result of the rear wheels 70 receiving drive force from the drive shafts 60.

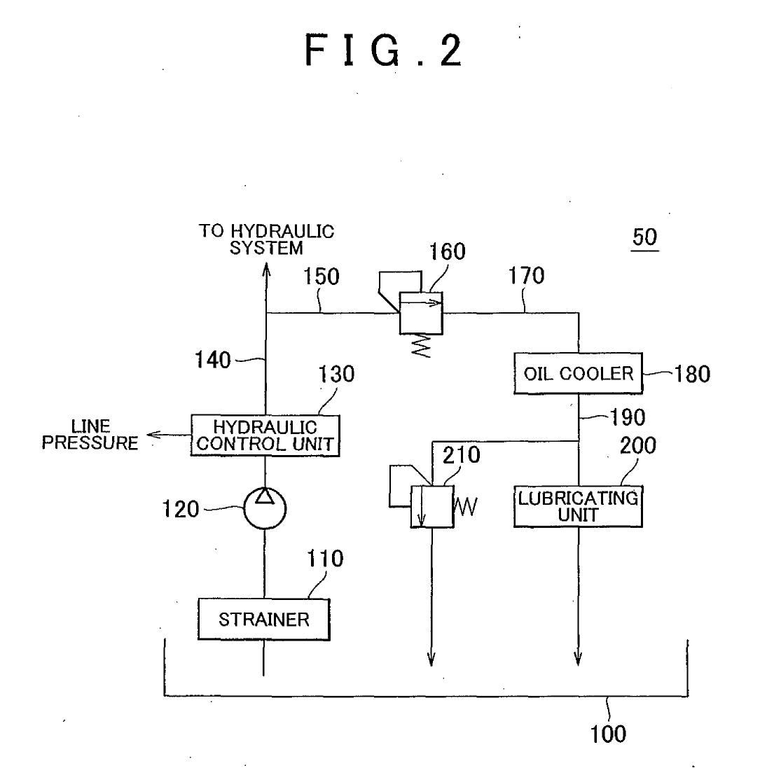

FIG. 2 is a drawing showing the configuration of the hydraulic circuit 50 shown in FIG. 1. The hydraulic circuit 50 contains an oil pan 100, an oil strainer 110, an oil pump 120, a hydraulic control unit 130 and a hydraulic oil path 140. In addition, the hydraulic circuit 50 further contains a regulator valve 160, an oil cooler 180, a lubricating unit 200, a relief valve 210 and oil paths 150, 170 and 190.

The oil pan 100 accumulates hydraulic oil circulated through the transmission 30. Furthermore, hydraulic oil that has accumulated in the oil pan 100 is agitated by a rotating body (not shown) in the speed changing unit 40 (FIG. 1). Thus, when the temperature of the hydraulic oil rises, the oil level of hydraulic oil in the oil pan 100 rises due to volumetric expansion of the hydraulic oil, thereby leading to a decrease in efficiency of the transmission 30 due to an increase in resistance of the hydraulic oil in the oil pan 100 to agitation. Therefore, in this first embodiment, measures are deployed for improving the cooling capacity of the hydraulic oil as described hereinafter.

The oil strainer 110 is configured to be able to remove foreign objects contained in hydraulic oil suctioned from the oil pan 100 by the oil pump 120. The oil pump 120 suctions hydraulic oil accumulated in the oil pan 100 through the oil strainer 110 and supplies the hydraulic oil to the hydraulic control unit 130 by generating oil pressure. Furthermore, the oil pump 120 may be driven using the output of the power generating device 20 (FIG. 1) or may be driven electrically.

The hydraulic control unit 130 generates a regulated line pressure in the speed changing unit 40 (FIG. 1) to activate frictional engagement elements (such as a clutch or brakes) by receiving hydraulic oil pressurized by the oil pump 120 from the oil pump 120. In addition, the hydraulic control unit 130 supplies hydraulic oil to the hydraulic oil path 140 for supplying hydraulic oil to hydraulic systems including a lock-up clutch and other hydraulic equipment.

The regulator valve 160 is provided in the oil path 150 branched from the hydraulic oil path 140, and regulates oil pressure within the hydraulic oil path 140. As an example thereof, the regulator valve 160 is composed of a valve body and a spring, and when the oil pressure in the oil path 150 exceeds a set pressure determined by the spring, the valve body operates to allow hydraulic oil to flow from the oil path 150 to the oil path 170 thereby regulating the oil pressure in the hydraulic oil path 140 to a constant pressure.

The oil cooler 180 is arranged between the oil path 170 and the oil path 190. The oil cooler 180 cools hydraulic oil supplied from the regulator valve 160 through the oil path 170 and supplies the cooled hydraulic oil to the oil path 190.

The lubricating unit 200 summarily indicates a site where lubricating oil is supplied, such as a rotating component, sliding component or bearing and the like, in the transmission 30 (FIG. 1). The lubricating unit 200 receives hydraulic oil cooled by the oil cooler 180 from the oil path 190 in the form of lubricating oil. The lubricating oil supplied to the lubricating unit 200 is then discharged to the oil pan 100.

The relief valve 210 is connected to the oil path 190 for supplying hydraulic oil cooled by the oil cooler 180 (lubricating oil) to the lubricating unit 200, and regulates the oil pressure (lubrication pressure) of the hydraulic oil supplied to the lubricating unit 200. More specifically, the relief valve 210 regulates oil pressure within the oil path 190 by discharging a portion of the hydraulic oil from the oil path 190. As an example thereof, the relief valve 210 is composed of a valve body and a spring, and when the oil pressure in the oil path 190 exceeds a set pressure determined by the spring, the valve body operates to open a drain port, thereby regulating the oil pressure in the oil path 190 to a constant pressure. Hydraulic oil discharged from the relief valve 210 is recovered by the oil pan 100.

In this hydraulic circuit 50, the oil cooler 180 is arranged upstream of the lubricating unit 200 and the relief valve 210. Namely, together with cooling hydraulic oil supplied to the lubricating unit 200 (lubricating oil), it also cools hydraulic oil discharged by the relief valve 210 into the oil pan 100 that is not supplied to the lubricating unit 200. The reason for intentionally having hydraulic oil, discharged by the relief valve 210 into the oil pan 100 in order to regulate lubrication pressure, cooled by the oil cooler 180, is to increase the amount of oil that passes through the oil cooler 180.

When considering only lubrication performance in a lubricating unit, it is not necessarily required to cool hydraulic oil discharged into an oil pan that is not supplied to a lubricating unit by only cooling lubricating oil supplied to a lubricating unit. However, in this type of hydraulic circuit, since the amount of oil passing through the oil cooler is limited to lubricating oil only, hydraulic oil circulated within the hydraulic circuit cannot be cooled effectively. When the overall temperature of the hydraulic oil circulated within the hydraulic circuit rises, the oil level of hydraulic oil in the oil pan rises due to volumetric expansion of the hydraulic oil therein, thereby leading to a decrease in efficiency of the transmission due to an increase in the resistance of hydraulic oil in the oil pan to agitation.

Therefore, in this first embodiment, as a result of providing the oil cooler 180 upstream of the lubricating unit 200 and the relief valve 210, hydraulic oil discharged into the oil pan 100 by the relief valve 210 without being supplied to the lubricating unit 200 also passes through the oil cooler 180, thereby increasing the amount of hydraulic oil that passes through the oil cooler 180 resulting in the hydraulic oil that circulates through the hydraulic circuit 50 being cooled effectively.

As has been described above, in this first embodiment, since the oil cooler 180 is arranged upstream of the lubricating unit 200 and the relief valve 210, the amount of oil passing through the oil cooler 180 increases as compared with a hydraulic circuit in which only hydraulic oil supplied to a lubricating unit is cooled. Thus, according to this first embodiment, hydraulic oil can be cooled effectively and at low cost without providing a separate high-performance cooler.

In addition, as a result of hydraulic oil being cooled effectively in this first embodiment, a rise in the oil level in the oil pan is inhibited. Thus, according to this first embodiment, a decrease in efficiency of the transmission 30 can be prevented. As a result, poor fuel consumption can also be prevented.

### Second Embodiment

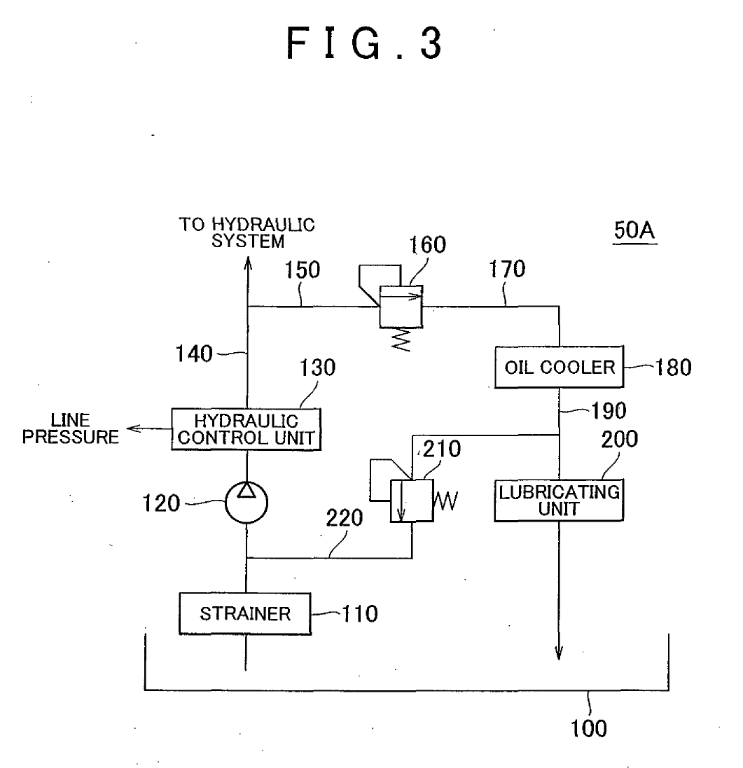

FIG. 3 is a drawing showing the configuration of a hydraulic circuit 50A according to a second embodiment. This hydraulic circuit 50A further contains a reflux circuit 220 in the configuration of the hydraulic circuit 50 according to the first embodiment shown in FIG. 2.

One end of this reflux circuit 220 is connected to a drain port of the relief valve 210, while the other end is connected between the oil strainer 110 and the oil pump 120. The reflux circuit 220 refluxes hydraulic oil discharged from the relief valve 210 to the oil pump 120 without discharging into the oil pan 100.

Furthermore, other constituents of the hydraulic circuit 50A are the same as those of the hydraulic circuit 50. In this hydraulic circuit 50A as well, the oil cooler 180 is arranged upstream of the lubricating unit 200 and the relief valve 210. Namely, together with cooling hydraulic oil supplied to the lubricating unit 200 (lubricating oil), the oil cooler 180 cools hydraulic oil discharged from the relief valve 210 without being supplied to the lubricating unit 200. In this hydraulic circuit 50A, cooled hydraulic oil discharged from the relief valve 210 is re-supplied to the oil pump 120 without being returned to the oil pan 100. As a result, since oil pressure from the relief valve 210 also acts on the reflux circuit 220, the suction load on the oil pump 120 is reduced. In addition, the temperature of the hydraulic oil circulating through the hydraulic circuit 50A is stabilized (lowered).

Thus, according to this second embodiment, the suction load on the oil pump 120 can be reduced. In addition, the temperature of the circulating hydraulic oil can be stabilized.

### Third Embodiment

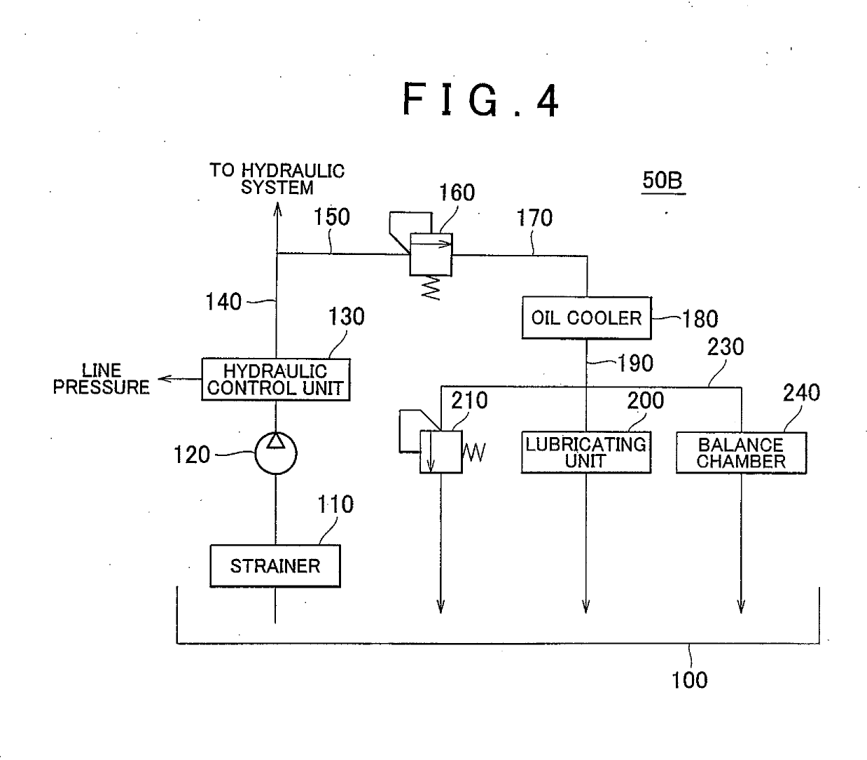

FIG. 4 is a drawing showing the configuration of a hydraulic circuit 50B according to a third embodiment. This hydraulic circuit 50B further contains a balancing path 230 and a balance chamber 240 in the configuration of the hydraulic circuit 50 according to the first embodiment shown in FIG. 2.

The balancing path 230 supplies hydraulic oil to the balance chamber 240 as a result of being branched from the oil path 190 between the oil cooler 180 and the lubricating unit 200. The balance chamber 240 is an oil chamber for generating oil pressure in opposition to centrifugal oil pressure generated accompanying rotation of a rotating body (not shown) in the speed changing unit 40 (FIG. 1). Namely, when the rotating body rotates, the oil chamber supplying oil pressure to frictional engagement elements also rotates, thereby generating centrifugal oil pressure separate from the hydraulic pressure due to the action of centrifugal force. This centrifugal oil pressure impairs controllability of the frictional engagement elements. Therefore, the balance chamber 240 is provided that rotates together with the rotating body, thereby generating centrifugal oil pressure that cancels out the centrifugal oil pressure generated in the oil chamber supplying oil pressure to the frictional engagement elements. Furthermore, a conventional configuration can be used for the configuration of this balance chamber 240. Hydraulic oil supplied to the balance chamber 240 is discharged into the oil pan 100.

Furthermore, other constituents of the hydraulic circuit 50B are the same as those of the hydraulic circuit 50. In this hydraulic circuit 50B, the balancing path 230 is branched from the oil path 190 between the oil cooler 180 and the lubricating unit 200. Namely, the oil cooler 180 is arranged upstream from the lubricating unit 200, the relief valve 210 and the balance chamber 240. Together with cooling hydraulic oil supplied to the lubricating unit 200 (lubricating oil) and hydraulic oil discharged from the relief valve 210, the oil cooler 180 also cools hydraulic oil supplied to the balance chamber 240. As a result, the amount of oil passing through the oil cooler 180 is further increased.

Thus, according to this third embodiment, hydraulic oil can be cooled more effectively.

### Fourth Embodiment

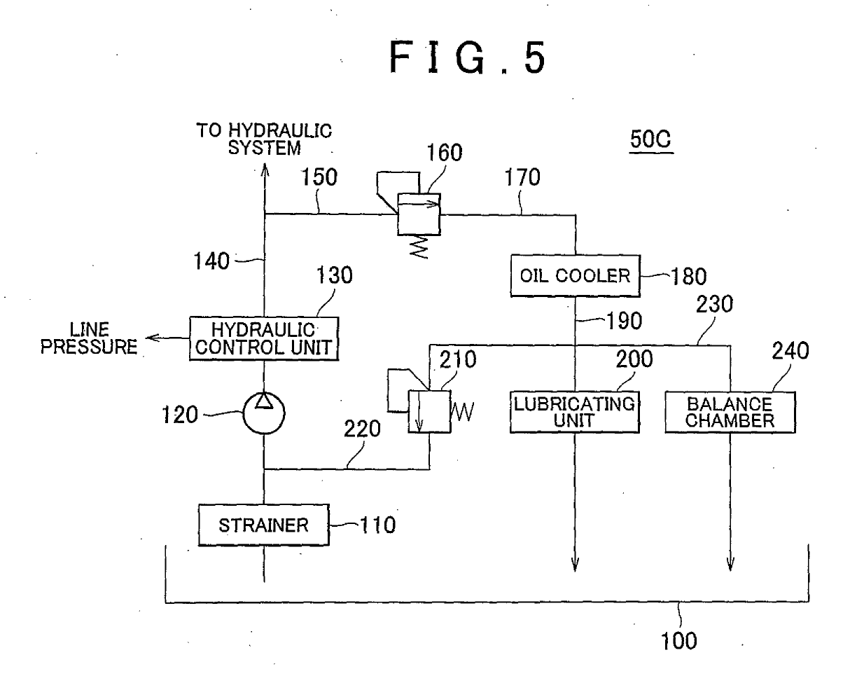

FIG. 5 is a drawing showing the configuration of a hydraulic circuit 50C according to a fourth embodiment. This hydraulic circuit 50C further contains the reflux circuit 220 in the configuration of the hydraulic circuit 50B according to the third embodiment shown in FIG. 4. The reflux circuit 220 is as was previously described.

Thus, in this fourth embodiment as well, the suction load on the oil pump 120 can be reduced. In addition, the temperature of hydraulic oil circulating through the hydraulic circuit 50C is stabilized (lowered).

### Fifth Embodiment

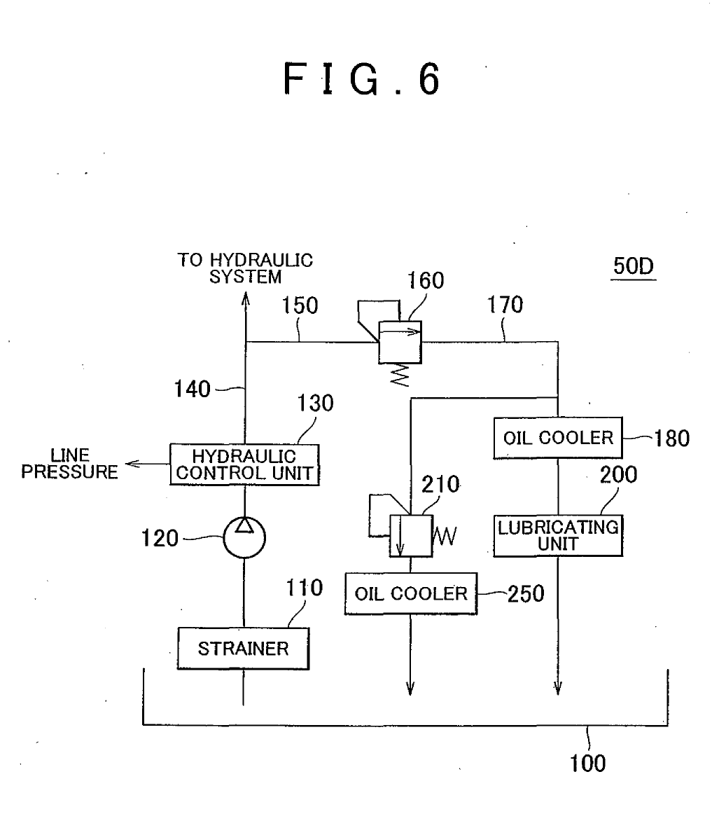

FIG. 6 is a drawing showing the configuration of a hydraulic circuit 50D according to a fifth embodiment. The hydraulic circuit 50D has the oil cooler 180 arranged between the lubricating unit 200 and the branching point between the lubricating unit 200 and the relief valve 210, and further contains an oil cooler 250 downstream from the relief valve 210 in the configuration of the hydraulic circuit 50 according to the first embodiment shown in FIG. 2.

In this hydraulic circuit 50D, the relief valve 210 is connected to the oil path 170. The oil cooler 180 cools hydraulic oil supplied from the oil path 170, and the cooled hydraulic oil is supplied to the lubricating unit 200 in the form of lubricating oil.

The oil cooler 250 is connected to a drain port of the relief valve 210. The oil cooler 250 discharges hydraulic oil discharged from the relief valve 210 into the oil pan 100.

Furthermore, other constituents of the hydraulic circuit 50D are the same as those of the hydraulic circuit 50. In this hydraulic circuit 50D, the relief valve 210 is connected to the oil path 170 upstream of the oil cooler 180, and the oil cooler 180 only cools hydraulic oil supplied to the lubricating unit 200. Hydraulic oil flowing to the relief valve 210 is cooled by the oil cooler 250.

Thus, according to this fifth embodiment as well, since the amount of cooled oil is increased as compared with a hydraulic circuit that only cools lubricating oil, hydraulic oil can be cooled effectively. In addition, since a rise in the oil level in the oil pan is inhibited as a result of the hydraulic oil being cooled effectively, a decrease in efficiency of the transmission 30 can be prevented.

### Sixth Embodiment

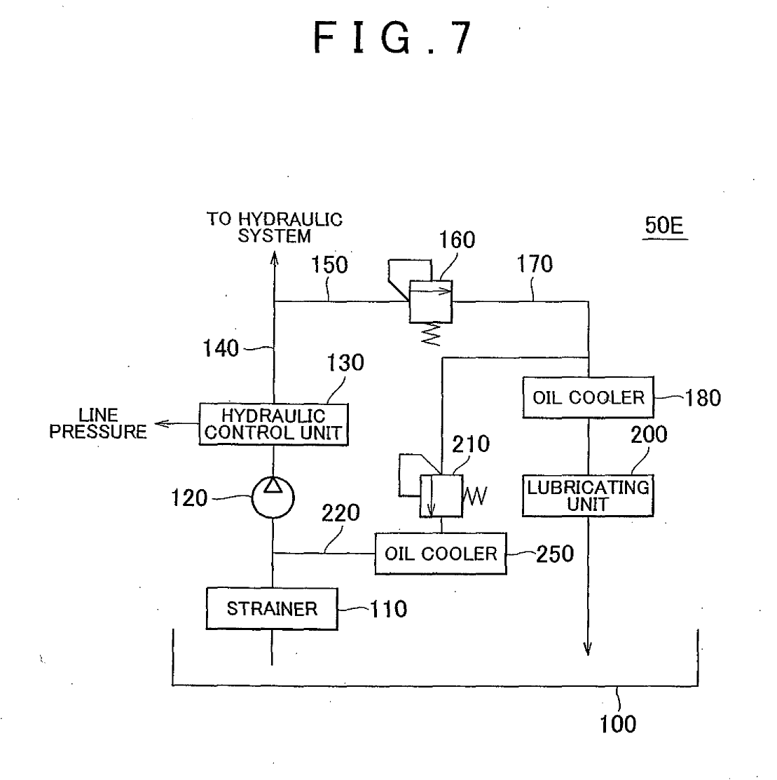

FIG. 7 is a drawing showing the configuration of a hydraulic circuit 50E according to a sixth embodiment. This hydraulic circuit 50E further contains a reflux circuit 220 in the configuration of the hydraulic circuit 50D according to the fifth embodiment shown in FIG. 6. The reflux circuit 220 is as was previously described.

Thus, according to this sixth embodiment as well, the suction load on the oil pump 120 can be reduced. In addition, the temperature of hydraulic oil circulating through the hydraulic circuit 50E is stabilized (lowered).

Furthermore, in each of the previously described embodiments, the oil path 190 can be considered to be equivalent to the “oil path” in the invention, and the relief valve 210 can be considered to be equivalent to the “hydraulic control valve”. In addition, the oil cooler 180 can be considered to be equivalent to the “cooler” in the invention, and the oil pump 120 can be considered to be equivalent to the “pump” in the invention.

While the invention has been described with reference to the example embodiments thereof, it is to be understood that the invention is not limited to the described embodiments or constructions. To the contrary, the invention is intended to cover various modifications and equivalent arrangements. In addition, while the various elements of the disclosed invention are shown in various example combinations and configurations, other combinations and configurations, including more, less or only a single element, are also within the scope of the appended claims.

In the fifth embodiment shown in FIG. 6, the oil cooler 180 and the oil cooler 250 may be respectively arranged upstream or downstream of the lubricating unit 200 and the relief valve 210, respectively, provided they are downstream from the branching point of the lubricating unit 200 and the relief valve 210.

In the fifth embodiment shown in FIG. 6 and the sixth embodiment shown in FIG. 7, the balancing path 230 for supplying hydraulic oil to the balance chamber 240 may be contained branched from the oil path 190 downstream from the oil cooler 180.

1. (canceled)

2. The transmission hydraulic circuit according to claim 11, further comprising:
a pump for generating oil pressure by suctioning the hydraulic oil accumulated in the oil pan; and
a reflux circuit configured to be able to supply oil discharged from the hydraulic control valve to an intake port of the pump.

3. The transmission hydraulic circuit according to claim 2, further comprising an oil strainer provided between the oil pan and the pump,
wherein the reflux circuit is connected between the oil strainer and the pump.

4. The transmission hydraulic circuit according to claim 11, further comprising a balancing path branched from the oil path between the cooler and the lubricating unit, and configured to enable the hydraulic oil to be supplied to a balance chamber for generating oil pressure in opposition to centrifugal oil pressure generated as a result of rotation of a rotating body of the transmission,
wherein the cooler cools all the hydraulic oil flowing from the oil path to the lubricating unit, the hydraulic control valve and the balancing path.

5. (canceled)

6. The transmission hydraulic circuit according to claim 12, further comprising:
a pump for generating oil pressure by suctioning hydraulic oil accumulated in the oil pan; and
a reflux circuit configured to be able to supply oil discharged from the hydraulic control valve or the cooler to an intake port of the pump.

7. The transmission hydraulic circuit according to claim 6, further comprising an oil strainer provided between the oil pan and the pump,
wherein the reflux circuit is connected between the oil strainer and the pump.

8. The transmission hydraulic circuit according to claim 12, further comprising a balancing path branched from the oil path downstream of the cooler and configured to enable the hydraulic oil to be supplied to a balance chamber for generating oil pressure in opposition to centrifugal oil pressure generated as a result of rotation of a rotating body of the transmission,
wherein, the cooler cools the hydraulic oil flowing from the oil path to the lubricating unit and the balancing path.

9. A transmission comprising the hydraulic circuit according to claim 11.

10. A vehicle equipped with a transmission comprising the hydraulic circuit according to claim 11.

11. A transmission hydraulic circuit comprising:
an oil pan in which hydraulic oil accumulates;
an oil path through which the hydraulic oil flows;
a lubricating unit that receives the hydraulic oil as lubricating oil from the oil path and is configured to enable the lubricating oil to be discharged to the oil pan;
a hydraulic control valve configured to enable regulation of hydraulic pressure within the oil path by discharging a portion of the oil from the oil path to the oil pan; and
a cooler arranged upstream of the lubricating unit and the hydraulic control valve and configured to enable cooling of the hydraulic oil flowing from the oil path into the lubricating unit and the hydraulic control valve,
wherein the cooler cools all the hydraulic oil flowing to the lubricating unit and the hydraulic control valve.

12. A transmission hydraulic circuit comprising:
an oil pan in which hydraulic oil accumulates;
an oil path through which the hydraulic oil flows;
a lubricating unit that receives the hydraulic oil as lubricating oil from the oil path and is configured to enable the lubricating oil to be discharged to the oil pan;
a hydraulic control valve configured to enable regulation of hydraulic pressure within the oil path by discharging a portion of the oil from the oil path;
a cooler arranged downstream of a branching point in the oil path between the lubricating unit and the hydraulic control valve, and upstream or downstream of the lubricating unit, and configured to be able to cool all the hydraulic oil flowing from the oil path to the lubricating unit; and
a cooler arranged downstream of a branching point in the oil path between the lubricating unit and the hydraulic control valve, and upstream or downstream of the hydraulic control valve, and configured to be able to cool all the hydraulic oil flowing from the oil path to the hydraulic control valve.

13. A transmission comprising the hydraulic circuit according to claim 12.

14. A vehicle equipped with a transmission comprising the hydraulic circuit according to claim 12.
